(19) United States
(12) Patent Application Publication
(10) Pub. No.: US 2013/0234651 A1
(43) Pub. Date: Sep. 12, 2013

(54) PROGRAMMABLE CABIN CONDITIONER FOR AN ELECTRIC VEHICLE AND METHOD OF CONDITIONING A CABIN OF AN ELECTRIC VEHICLE

(71) Applicant: Keith D. BUFORD, Southfield, MI (US)

(72) Inventor: Keith D. BUFORD, Southfield, MI (US)

(73) Assignee: GM GLOBAL TECHNOLOGY OPERATIONS LLC, Detroit, MI (US)

(21) Appl. No.: 13/418,024

(22) Filed: Mar. 12, 2012

(51) Int. Cl. H02J 7/00

(52) U.S. Cl. 320/107

(57) ABSTRACT

A programmable cabin conditioner for an electric vehicle includes a power charging system configured to provide power to a battery of the electric vehicle. Also included is a cabin conditioning system configured to receive input from a user to provide a desired cabin conditioning environment prior to a departure time, wherein the cabin conditioning system is operated during operation of the power charging system and subsequent to a fully charged state of the battery.

### FIELD OF THE INVENTION

The subject invention relates to electric and hybrid vehicles, and more particularly to a programmable cabin conditioner for such vehicles and methods for operating the same.

### BACKGROUND

Electric and hybrid vehicles (“electric vehicles”) often support a charging feature that provides a user the ability to program a charging time that enables a sufficient charging period to allow the electric vehicle to achieve a fully charged state prior to a departure time. The departure time corresponds to a time of day that the user desires to depart. Additionally, such electric vehicles often have a remote cabin conditioning feature that activates a prioritization of wall energy (i.e., grid energy) to condition a cabin of the electric vehicle. A key fob or similar remote device is employed by the user to activate the remote cabin conditioning feature. As a result of the prioritization of wall energy upon remote activation by the user, the range of the electric vehicle may be depleted to an extent less than that of a situation where the focus of wall energy is directed to charging of a battery. Additional drawbacks of reliance on the remote cabin conditioning feature include the requirement of the user to remember to activate the feature and limitations on radio frequency (RF) range of the remote device, for example.

### SUMMARY OF THE INVENTION

In one exemplary embodiment of the invention, a programmable cabin conditioner for an electric vehicle includes a power charging system configured to provide power to a battery of the electric vehicle. Also included is a cabin conditioning system configured to receive input from a user to provide a desired cabin conditioning environment prior to a departure time, wherein the cabin conditioning system is operated during operation of the power charging system and subsequent to a fully charged state of the battery.

In another exemplary embodiment of the invention, a programmable cabin conditioner for an electric vehicle includes a user interface configured to provide a user the ability to program a completion time for a desired cabin conditioning environment to be produced. Also included is a power charging system comprising a battery and a charging source for generating power to the battery of the electric vehicle. Further included is a controller in operable communication with the user interface for selectively determining an initiation time to provide the desired cabin conditioning environment and a fully charged state of the battery prior to the completion time provided by the user.

In yet another exemplary embodiment of the invention, a method of conditioning a cabin of an electric vehicle is provided. The method includes charging a battery of the electric vehicle with a power charging system. Also included is programming a cabin conditioning system to produce a desired cabin conditioning environment prior to a completion time. Further included is operating the cabin conditioning system during operation of the power charging system and subsequent to a fully charged state of the battery.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic view of an electric vehicle having a power charging system;

FIG. 2 graphically illustrates a charging schedule of the power charging system;

FIG. 3 is a simplified schematic of a controller of the electric vehicle receiving data from a power source; and

FIG. 4 is a flow diagram illustrating a method of conditioning a cabin of the electric vehicle.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

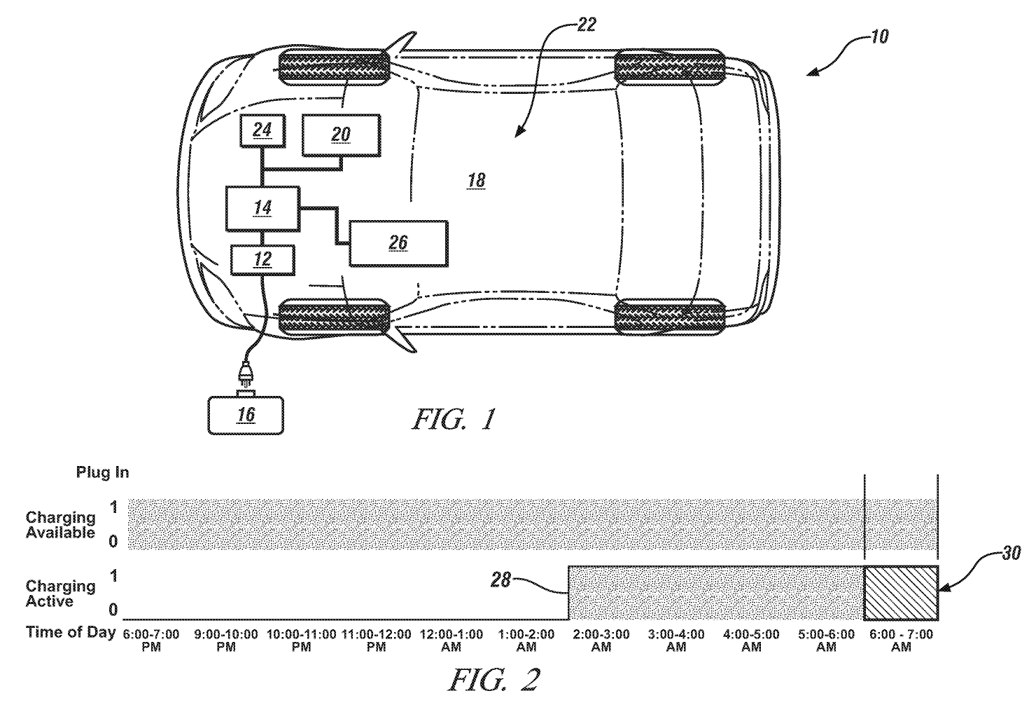

Referring to FIG. 1, in accordance with an exemplary embodiment of the invention, a simplified schematic representation of an electric vehicle is generally illustrated with reference numeral 10. Although illustrated and described herein as a plug-in electric vehicle, it is to be appreciated that contemplated embodiments of the present invention may also be applicable to a hybrid electric plug-in vehicle or a range extended electric vehicle.

The electric vehicle 10 includes a power charging system 12 that is in operable communication with an energy storage component 14. The energy storage component 14 may be a battery of the lithium-ion type, however, any suitable energy storage component 14 may be employed to achieve necessary functionality. Specifically, the energy storage component 14 is configured to draw energy from a power source 16, such as an industrial power energy grid that may be directly transferred to the power charging system 12 via a wall outlet, or a public charging station. As with all other energy provided appliances, the provision of power from the power source 16, when in the form of the industrial power energy grid, is charged at various rates, typically depending on the time of day and/or the day of the week. The energy storage component 14 is capable of powering the electric vehicle 10 and the available range of the electric vehicle is a function of the energy stored in the energy storage component 14.

The electric vehicle 10 also includes a passenger cabin 18 for seating of occupants of the electric vehicle 10. The passenger cabin 18 includes instruments that enable a user to operate various controls associated with driving of the electric vehicle, as well as instruments associated with entertainment and comfort of the user. One feature associated with user comfort is a cabin conditioning system 20 that provides the user the ability to control one or more atmospheric conditions inside the passenger cabin 18 using a heating, ventilation and air conditioning (“HVAC”) system. Various options are available for the user to activate and control the cabin conditioning system 20. One known option is direct and instant manual control while the user is in the passenger cabin 18. This may be in the form of directly activating buttons, knobs, or the like, with the user's hand, or alternatively may be a hands-free activation, such as a system that allows speaking commands by the user. Another option for activating and controlling the cabin conditioning system 20 includes the use of a remote device, such as a fob that typically employs a radio-frequency (RF) signal. The remote device allows the user to activate and control the cabin conditioning system 20 while in a location within a specified RF range. Each of the above-described options require a period of time from the activation by the user to achieve a desired cabin conditioning environment 22, such as a target temperature, thereby leaving the passenger cabin 18 either above or below the desired cabin conditioning environment 22 for a certain time period.

In addition to the activation and control schemes described above, the electric vehicle also includes a user interface 24 that is disposed in the passenger cabin 18 and is in operable communication with the cabin conditioning system 20. The user interface 24 provides the user the ability to program the cabin conditioning system 20 for future usage, rather than instantaneous activation and control, as is the case with the above described options. Such a feature reduces or eliminates the time period that the user is required to endure cabin conditions other than the desired cabin conditioning environment 22. By way of example, the user can employ the user interface 24 to input a departure time which corresponds to the time which the user desires achievement of the desired cabin conditioning environment 22. For instance, the user may be aware of a specific time of day that completion must occur and the specific time is received by a controller 26 that is in operable communication with the user interface 24 and the cabin conditioning system 20. The controller 26 is configured for receiving a variety of information and is configured to perform numerous functions associated with operation of the electric vehicle 10, with one or more such functions associated with the cabin conditioning system 20. Upon receipt of the departure time from the user interface 24, the controller 26 selectively determines an initiation time that will adequately produce the desired cabin conditioning environment 22. The determination is based on a number of factors, and in the case of a target temperature, the predominant factors are the exterior temperature and the interior temperature, with respect to the passenger cabin 18. The controller 26 is also in operable communication with the power charging system 12, thereby enabling the controller 26 to receive and transmit data relating to overall charging of the energy storage component 14.

Referring to FIG. 2, a graphical illustration of a charging sequence is shown. Specifically, and by way of example, the user enables the power charging system 12 to draw power from the power source 16 from the hours of 6:00 PM until 7:00 AM. The controller 26 has determined the initiation time that will sufficiently provide the desired cabin conditioning environment 22 at or before the desired departure time that the user provided to the user interface 24. Additionally, the controller 26 selectively determines a charging start time 28 that is partially based on the desired cabin conditioning environment 22 and the departure time. In the illustrated example, the charging start time 28 corresponds to 2:00 AM. As shown, while charging is available and prior to the departure time, the cabin conditioning system 20 is active between 6:00 AM and 7:00 AM. Here, the departure time 30 corresponds to 7:00 AM. It is to be appreciated that the durations illustrated are merely representative and actual charging time and cabin conditioning time durations will vary based on a variety of factors. Also, it is to be understood that charging of the energy storage component 14 may be performed simultaneously or at a distinct time from that of the cabin conditioning.

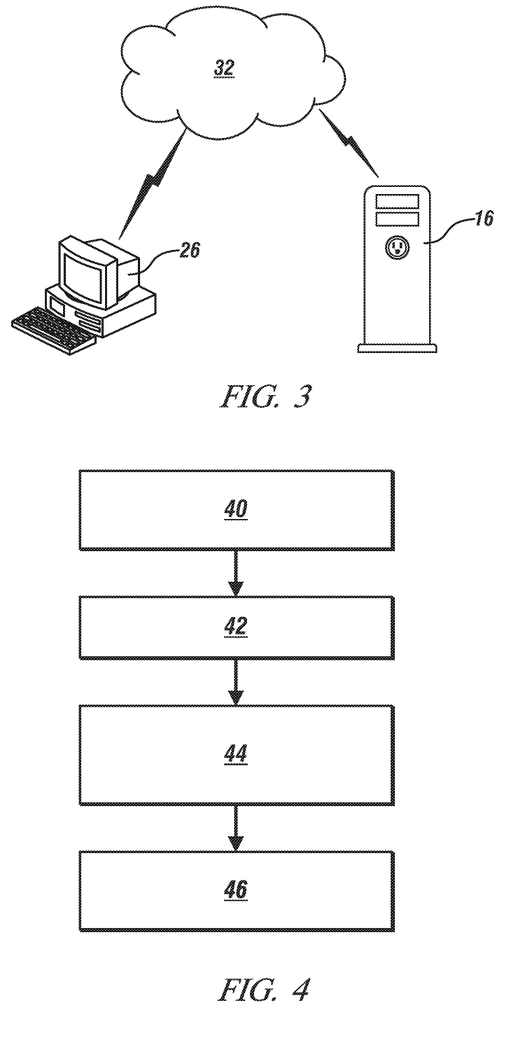

Referring to FIG. 3, a simplified schematic illustrates another consideration that the controller 26 may be subject to in the determination of the charging start time 28 and operation of the power charging system 12. The controller 26 receives data through an intermediary 32, which may be a wireless connection. As described above, drawing power or energy from the power source 16, when in the form of the industrial power energy grid, is charged at various rates, typically depending on the time of day and/or the day of the week. The controller 26 may be configured to receive data sufficient to generate a power cost schedule that comprises a plurality of power rates at a plurality of times for each day of the week. The controller 26 is configured to attempt to charge the energy storage component 14 of the electric vehicle 10 at a minimum cost time according to the power cost schedule. Providing the controller 26 with the departure time allows the controller 26 to determine the minimum cost time to conduct the charging, while still adequately achieving the desired cabin conditioning environment 22 prior to the departure time. Alternatively, the power charging system 12 and/or the controller 26 may be in operable communication with a local power meter that provides further energy efficiency enhancement.

Referring to FIG. 4, a flow diagram generally illustrates a method of conditioning the passenger cabin. The electric vehicle 10 and associated components have been previously described and specific components need not be described in further detail. The method includes charging 40 the energy storage component 14, such as a battery, with the power charging system 12. Prior to or subsequent to charging 40 of the energy storage component 14, the cabin conditioning system 20 is programmed 42 by the user. The programming 42 may include the desired cabin conditioning environment 22 and/or a departure time. Based on the programmed input, which may be communicated through a number of components, such as the user interface 24 and the controller 26, detection 44 is made of an initiation time for active charging and initiation of the cabin conditioning system 20. The initiation time provides the desired cabin conditioning environment 22 and a fully charged state of the battery prior to the departure time. The cabin conditioning system 20 is operated 46 subsequent to charging 40 of the energy storage component 14.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A programmable cabin conditioner for an electric vehicle comprising:
a power charging system configured to provide power to a battery of the electric vehicle; and
a cabin conditioning system configured to receive input from a user to provide a desired cabin conditioning environment prior to a departure time, wherein the cabin conditioning system is operated during operation of the power charging system and subsequent to a fully charged state of the battery.

2. The programmable cabin conditioner of claim 1, wherein the desired cabin conditioning environment comprises a target temperature.

3. The programmable cabin conditioner of claim 2, wherein the cabin conditioning system selectively determines an initiation time to achieve the target temperature prior to the departure time selected by the user.

4. The programmable cabin conditioner of claim 2, wherein the cabin conditioning system is configured to provide the desired cabin conditioning system for a plurality of departure times.

5. The programmable cabin conditioner of claim 4, wherein the plurality of departure times occurs on a plurality of days.

6. The programmable cabin conditioner of claim 2, wherein the power charging system receives a power cost schedule.

7. The programmable cabin conditioner of claim 6, wherein the power charging system provides power to the battery at a minimum cost time of the power cost schedule.

8. A programmable cabin conditioner for an electric vehicle comprising:
a user interface configured to provide a user the ability to program a completion time for a desired cabin conditioning environment to be produced;
a power charging system comprising a battery and a charging source for generating power to the battery of the electric vehicle; and
a controller in operable communication with the user interface for selectively determining an initiation time to provide the desired cabin conditioning environment and a fully charged state of the battery prior to the completion time provided by the user.

9. The programmable cabin conditioner of claim 8, wherein the desired cabin conditioning environment comprises a target temperature.

10. The programmable cabin conditioner of claim 9, wherein the user interface receives a plurality of completion times from the user.

11. The programmable cabin conditioner of claim 10, wherein the plurality of completion times occurs on a plurality of days.

12. The programmable cabin conditioner of claim 9, wherein the power charging system receives a power cost schedule.

13. The programmable cabin conditioner of claim 12, wherein the power charging system provides power to the battery at a minimum cost time of the power cost schedule.

14. The programmable cabin conditioner of claim 9, wherein the user interface is disposed at an onboard location of the electric vehicle.

15. The programmable cabin conditioner of claim 14, wherein the user interface comprises a remote device.

16. A method of conditioning a cabin of an electric vehicle comprising:
charging a battery of the electric vehicle with a power charging system;
programming a cabin conditioning system to produce a desired cabin conditioning environment prior to a completion time; and
operating the cabin conditioning system during operation of the power charging system and subsequent to a fully charged state of the battery.

17. The method of claim 16, further comprising selectively detecting an initiation time capable of providing the desired cabin conditioning environment prior to the completion time.

18. The method of claim 16, wherein the desired cabin conditioning environment comprises a target temperature.

19. The method of claim 16, further comprising programming a plurality of completion times.

20. The method of claim 19, wherein the plurality of completion times occur on a plurality of days.
